(19) United States
(12) Patent Application Publication
(10) Pub. No.: US 2022/0066765 A1
(43) Pub. Date: Mar. 3, 2022

(54) SYSTEMS AND METHODS FOR EXECUTING DYNAMIC CODE IN A SOFTWARE CONTAINER

(71) Applicant: Banque Nationale Du Canada, Montreal (CA)

(72) Inventor: Alain LAVOIE, Montreal (CA)

(21) Appl. No.: 17/446,326

(22) Filed: Aug. 30, 2021

Related U.S. Application Data
(60) Provisional application No. 63/073,966, filed on Sep. 3, 2020.

(51) Int. Cl. G06F 8/61; G06F 8/71; G06F 9/455

(52) U.S. Cl. CPC G06F 8/63; G06F 8/71; G06F 2009/45579; G06F 9/45558; G06F 9/45508

(57) ABSTRACT

A method for executing dynamic code in a container image is described. The method includes running a first instance of the container image; retrieving first computer code from a first defined location and executing the retrieved computer code in the first instance; running a second instance of the container image; retrieving second computer code from a second defined location and executing the retrieved second computer code on the second instance. A corresponding system and non-transitory computer-readable medium are also described.

### RELATED APPLICATION

The present application claims the benefit of and priority to U.S. Provisional Patent Application No. 63/073,966 filed Sep. 3, 2020, and entitled “SYSTEMS AND METHODS FOR EXECUTING DYNAMIC CODE IN A SOFTWARE CONTAINER”, the entirety of which is hereby incorporated by reference herein.

### FIELD

The field generally relates to software containers. More specifically, it relates to systems and methods for executing dynamic code in a software container.

### BACKGROUND

A software container is a mechanism that allows for software to be virtually packaged and isolated for deployment. A container consists of a virtualized runtime environment that allows applications to be abstracted from the environment in which they actually run.

Software containers can be instantiated from a container image. A container image is a static file that includes an entire runtime environment, including a software application's executable code and any dependencies needed to run the application, such as any required libraries, tools, configuration files, etc.

By definition, a container image is immutable. Accordingly, if a software application in a container needs to be modified, a new container image must be created. As can be appreciated, in cases where a containerized software application needs to be modified often, this can result in having to store, maintain, and access many different container images. This can be time consuming and costs bandwidth and storage.

### SUMMARY

According to an aspect, a method for executing dynamic code in a container image is provided. The method includes: running a first instance of the container image on a first host server; retrieving first computer code from a first defined location external to the container image; causing a code execution module in the first instance of the container image to execute the retrieved computer code; running a second instance of the container image on the first host server or on a second host server; retrieving second computer code from a second defined location external to the container image; and causing a code execution module in the second instance of the container image to execute the retrieved second computer code.

According to an aspect, a system for executing dynamic code is provided. The system incudes: memory storing a container image, a first instance of the container image running on a first host server, and a second instance of the container image running on the first host server or on a second host server. The container image includes: a code import module configured to retrieve computer code from a defined location external to the container image; and a code execution module configured to execute the retrieved computer code. The code import module of the first instance of the container image is configured to retrieve first computer code from a first defined location external to the first instance of the container image; and the code execution module of the first instance of the container image is configured to execute the first retrieved computer code. The code import module of the second instance of the container image is configured to retrieve second computer code from a second defined location external to the second instance of the container image; and the code execution module of the second instance of the container image is configured to execute the second retrieved computer code.

### BRIEF DESCRIPTION OF THE DRAWINGS

FIG. 1 is a schematic illustrating a system for containerized software development, according to an embodiment.

FIG. 2 is a schematic illustrating a method for executing dynamic code in containers images in the system of FIG. 1, according to an embodiment.

FIG. 3 is a detail view illustrating operation of code execution module in a container, according to an embodiment.

FIG. 4 is a flowchart illustrating a software development process, according to an embodiment.

### DETAILED DESCRIPTION

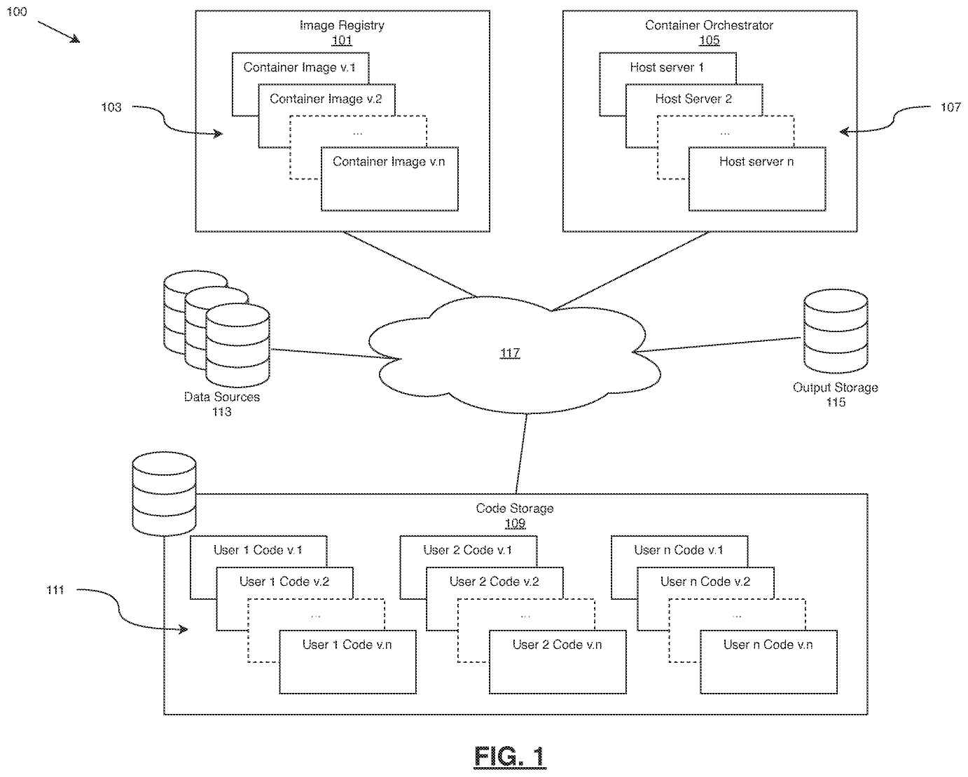

With reference to FIG. 1, a system 100 for containerized software development is shown according to an embodiment. Broadly described, the system 100 includes an image registry 101, a container orchestrator 105, code storage 109, a plurality of data sources 113, and output storage 115. Each of these components can communicate with one another via a network 117, such as a local area network (LAN), wide area network (WAN), the internet, and/or other networks or combinations thereof.

The image registry 101 is a service configured to host and distribute container images 103. Once a container image 103 is created, it can be stored on the image registry 101 so that it can be subsequently accessed and used. In the present embodiment, the image registry 101 is a shared registry, allowing for container images 103 stored thereon to be shared among users, such as a team of developers. As an example, a first user can create a container image and store it on the registry 101. The first user and/or one or more second users can subsequently pull a copy of the image from the registry 101 to run separate instances of the same container as defined by the image. In the present embodiment, the shared registry 101 is private in that only a group of authorized users (such as the team of developers) can have access thereto. Moreover, different permissions can be granted to different users, such that only some users can be authorized to write (i.e., push) to the registry 101, while others can only be authorized to read (i.e., pull). It is appreciated that other configurations of registry 101 are possible. For example, in some embodiments, the registry 101 can be a public registry.

In the present embodiment, the registry 101 is configured as a repository in that it can store and keep track of a collection of related images, such as multiple versions of container image 103. As an example, an initial version of a container image can be stored in the registry 101 (ex. v.1). If a user modifies the container defined by the initial image, they will need to subsequently create a new image to define the modified container. This new image can be pushed back to the registry 101 and, instead of overwriting the initial version of the container image, the new container image can be stored as a new version in the registry 101 (ex. v.2). This can continue for any other number of versions n of the container image. A user can subsequently pull the latest version of the container version 103 or choose to pull any previous version (ex. v.1, v.2, v.n). Although version numbers have been described for keeping track of related images, it is appreciated that other tagging schemes are possible.

The container orchestrator 105 is a system configured to substantially automate the deployment, management, scaling, and networking of containers. The container orchestrator 105 can, for example, be implemented via the Kubernetes platform, although it is appreciated that other platforms are also possible. In some implementations, the container orchestrator 105 can facilitate managing a plurality of host servers 107 comprising physical and/or virtual machines running one or more operating systems, such that container instances can be run thereon. The container orchestrator 105 can further communicate with image registry 101 to facilitate deployment of container images 103 on the host servers 107. As an example, a user can issue a command to the container orchestrator 105 to run a new instance of a given container image. The container orchestrator 105 can then pull the appropriate container image from the image registry 101, identify a suitable host server 107, and then run an instance of the container image on the identified host server 107 using an appropriate container platform, such as Docker or any other suitable platform. Although not explicitly described herein, one skilled in the art will appreciate that the container orchestrator 105 can provide various other functionalities.

The code storage 109 comprises persistent storage allowing for user-created code 111 to be stored and subsequently accessed. As can be appreciated, the code storage 109 can be implemented via various mechanisms. For example, in some embodiments, the code storage 109 can comprise a code repository service, allowing for storing and maintaining different versions of code. In such embodiments, the code storage 109 can store code for a plurality of users and maintain a plurality of versions of each user's code. It is appreciated that the code storage 109 can comprise other storage mechanisms. For example, the code storage 109 can comprise one or more databases and/or one or more file systems. It is further appreciated that the code storage 109 can comprise different storage locations, such as network storage and/or storage that is local to a user workstation and/or to a host server 107. Preferably, at least some of the code storage 109 is accessible to the container orchestrator 105, to the host servers 107, and/or to containers running on the host servers 107.

As can be appreciated, various types of code 111 can be stored on code storage 109. For example, the code 111 can comprise source files in one or more programming languages, including compiled languages (such as C++) and scripting languages (such as Python). The code 111 can further comprise compiled code, such as executable binaries and/or libraries. In the present embodiment, and as will be described in more detail hereinafter, the stored code 111 comprises dynamic code that can be imported into, and executed by, a running container.

In addition to code storage 109, the system 100 can further include data sources 113 and output storage 115. Data sources 113 can comprise one or more persistent storage locations and/or databases that provide data that can be used as an input to containerized applications. Such data sources 113 can be provided, for example, by one or more data vendors. Similarly, output storage 115 can comprise one or more persistent storage locations and/or databases that provide a location for storing output data of containerized applications. As an example, in embodiments where a containerized application is configured to predict commodity pricing based on weather data, the data sources 113 can comprise current and/or historical weather data and commodity pricing acquired from a data vendor, and the output storage 115 can store predicted outcomes and/or application logs. It is appreciated, however, that many other configurations are possible.

Although in the illustrated embodiment the code storage 109, data sources 113, and output storage 115 are illustrated as separate logical entities, it is appreciated that they can be at least partially implemented using a common storage service, such as Amazon S3 or another suitable service.

As can be appreciated, the above-described system 100 can allow users to develop, share, and test containerized applications for rapid deployment. In a first example, the system 100 can be used to develop a containerized artificial intelligence (AI) model. A first user can program a first iteration of an AI algorithm and store their source code on code storage 109. The AI algorithm could, for example, analyze consumer data to identify consumers in need of financial assistance, such as payment deferments on loans. When the first user is satisfied with the first iteration of the AI algorithm, the AI model can be packaged in a container, saved as a container image, and pushed to the image registry 101. Once stored on the image registry 101, it can be deployed by the container orchestrator 105 for testing. If changes are required, the first user can create one or more subsequent iterations of the AI algorithm and repackage the AI model with the subsequent algorithm iterations for testing using containers. Meanwhile, second users can also work on their own iterations of the AI algorithm and deploy them for testing in a similar manner using containers. The iterative development process can continue by first and second users until the AI model behaves as desired and is ready for deployment in a production environment.

As a second example, the system 100 can be used to develop a containerized trading application. A first user can program a first iteration of a trading algorithm and store their source code on code storage 109. The trading algorithm can, for example, include various logical operations defining when to buy and/or sell stocks based on different parameters. In some embodiments, such logical operations can utilize one or more trained AI models or business rules. When the first user is satisfied with the first iteration of the trading algorithm, the trading application can be packaged in a container, saved as a container image, and pushed to the image registry 101. Once stored on the image registry 101, it can be deployed by the container orchestrator 105 for testing. If changes are required, the first user can create one or more subsequent iterations of the trading algorithm and repackage the trading application with the subsequent algorithm iterations for testing using containers. Meanwhile, second users can also work on their own iterations of the trading algorithm and deploy them, for testing in a similar manner using containers. The iterative development process can continue by first and second users until the trading application behaves as desired and is ready for deployment in a production environment.

As discussed above, a container image is immutable by definition. Accordingly, under normal circumstances, each iteration of the trading algorithm would require generating a new, distinct container image containing the trading application with the new iteration of the algorithm. Generating a new image for each iteration of the trading algorithm can significantly slow down the development of the trading algorithm and can require managing a large volume of different container images. It is therefore preferred to have a container configuration and corresponding method that allows a single container to run different iterations of code without having to generate and deploy a new container image each time.

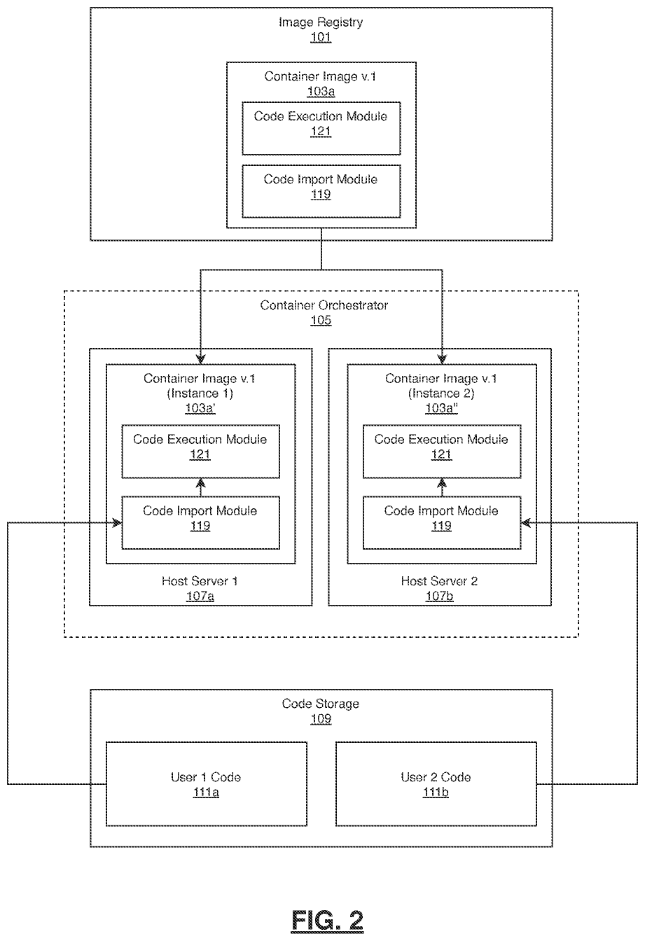

Accordingly, with additional reference to FIG. 2, a method for utilizing the system 100 to execute dynamic code in a container is shown according to an embodiment. As will be described in more detail hereinafter, dynamic code corresponds to code that is not a fixed as part of a container image (i.e., is not “packaged” as part of the container). Instead, dynamic code corresponds to code that can be provided and/or changed while a container instance is running. In this fashion, different instances of the same container can behave differently by executing one or more blocks of different dynamic code. Multiple iterations of dynamic code can thus be integrated in one or more instances of the same container without having to generate a new container image each time the dynamic code is changed.

In the method illustrated in FIG. 2, a first version of a container image 103a is stored on image registry 101. The container image 103a defines a container comprising a code import module 119 and a code execution module 121. The code import module 119 is configured to import code from a location that is external to the container, while the code execution module 121 is configured to execute at least some of the imported code within the environment of the container. As can be appreciated, external code can correspond to any code that is stored on a location external to the container, such that the code persists independent of whether the container is running or stopped. Although external code can be logically and/or physically stored outside the container, it is appreciated that the external code can be referenced, accessed and/or copied from inside the container via different mechanisms.

The container image 103a can be deployed by container orchestrator 105 to run a first instance 103a′ of the container image, in this case on a first host server 107a. Once the first instance 103a′ is running, the code import module 119 and code execution module 121 can operate to retrieve and execute dynamic code within the first instance 103a′. In particular, code import module 119 can retrieve first code 111a (such as a first user's code) from a first specified location, for example from a location on external code storage 109. Once the first code 111a is retrieved it can be executed by code execution module 121, along with any fixed code that may already be present in the container image 103a. The results of executing first code 111a can be subsequently output, for example via a user interface and/or by creating and storing an output file or log.

At any time while the first instance 103a′ is running or is stopped, the container image 103a can also be deployed by container orchestrator 105 to run a second instance 103a″ (or any number of subsequent instances) of the container image.

In the present embodiment, the second instance 103a″ is run on a second host server 107b, although it is appreciated that the second instance 103a″ could also be run on the first host server 107a. Once the second instance 103a″ is running, the code import module 119 and code execution module 121 can operate to retrieve and execute dynamic code within the second instance 103a″. In particular, code import module 119 can retrieve second code 111b (such as a second user's code, or a modified version of first code 111a) from a second specified location, for example from a location on external code storage 109. The second specified location can be different from the first specified location or can be the same, for example if the second code 111b corresponds to a modified version of the first code 111a. Once the second code 111b is retrieved it can be executed by code execution module 121, along with any fixed code that may already be present in the container image 103a. The results of executing second code 111b can be subsequently output, for example via a user interface and/or by creating and storing an output file or log.

In the method described above, a single container image 103a is used to create first 103a′ and second 103a″ container instances. Accordingly, the first 103a′ and second 103a″ instances will essentially be identical once instantiated. This can allow for first 111a and second 111b code to be separately executed in identical software runtime environments as defined by the image 103a, including the same operating system, runtime engines, environment variables, libraries, configurations, sources of data, etc. It is appreciated that in addition to the containers having identical software runtime environments (i.e., internal runtime environments), the host servers 107a and 107b can also be configured with substantially identical runtime environments, including the same hardware and/or software configurations. This can allow for the first 103a′ and second 103a″ container instances to be separately run in identical external runtime environments on host servers 107a and 107b.

Although in the above-described example the first 111a and second 111b code is executed in two separate container instances 103a′, 103a″, it is appreciated that in some embodiments the first 111a and second 111b code can both be executed in the same container instance 103a′. As an example, the code import module 119 on first container instance 103a′ can retrieve first code 111a (for example corresponding to a first version of a user's algorithm), and the first code 111a can be executed by code execution module 121 for validation and testing. The first code 111a can subsequently be modified (for example to create an updated version of the user's algorithm) to create second code 111b. The code import module 119 on first container instance 103a′ can then be operated to retrieve the second code 111b and overwrite and/or delete the first code 111a. The second code 111b can then be executed by code execution module 121 for validation and testing. In this fashion, two different versions of dynamic code 111a and 111b can be executed in identical runtime environments without having to expend resources running multiple container instances, and further without having to create and store multiple container images.

As mentioned above, the external code 111a, 111b can be retrieved by code import module 119 via different mechanisms. For example, in some embodiments, the code storage 109 can comprise cloud storage, and the import module 119 can be configured to download the code 111a, 111b from the cloud storage into the container instance 103a′, 103a″, such as via an HTTPS request. As another example, the code storage 109 can comprise local or network storage that is accessible to the host server 107a, 107, and the container instance 103a′, 103a″ can be instantiated with a mounted volume that points to the local or network storage. The import module 119 can subsequently access the code 111a, 111b through the volume for execution and/or download/copy the code 111a, 111b directly into the container instance 103a′, 103a″. As can be appreciated, the location of the code 111a, 111b can be defined via an argument or parameter that is provided when the container is instantiated. In some embodiments, the location can be provided after the container is instantiated, for example by providing the location to the running container via a signal or an API. In some embodiments, the location can be provided as a runtime parameter or argument to a script in the container that is configured to retrieve the code from the specified location. Of course, other configurations are also possible. For example, in some embodiments, a script can be configured to retrieve code directly from a predefined location on a local file system.

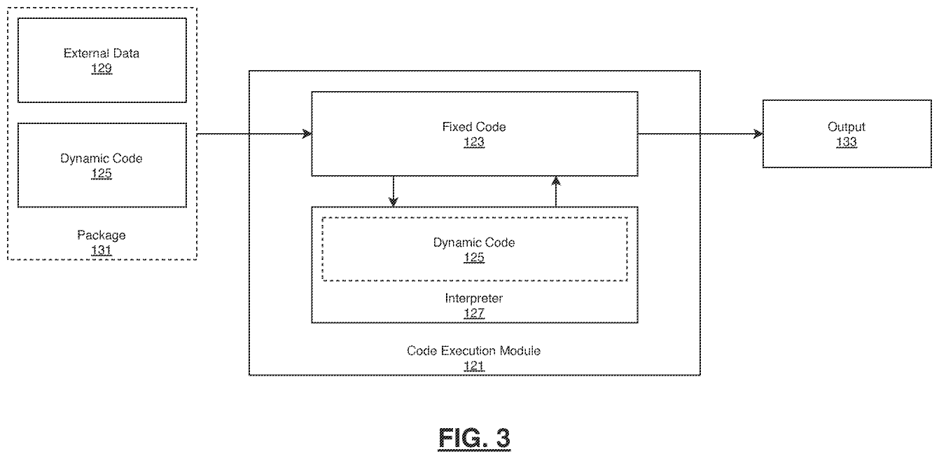

With further reference to FIG. 3, exemplary operation of code execution module 121 in container image 103a is shown in more detail. In the illustrated embodiment, the code execution module 121 comprises a fixed code component 123 and a dynamic code component 125. The fixed code 123 corresponds to code and/or data that is packaged as part of the container image 103a. In other words, fixed code 123 corresponds to code that exists in a container when the container is instantiated from the container image 103a. The fixed code 123 is the same in all new container instances created from image 103a. The fixed code 123 can comprise code to implement at least part of a software application, such as data and/or libraries. The fixed code 123 can further include generic or re-usable functions or scripts that can be called (for example by code import module 119) to retrieve external code and/or external data, to orchestrate execution of external code, and/or to produce output.

Dynamic code 125, on the other hand, corresponds to code that can differ from one instance of the container to another. In the present embodiment, the dynamic code 125 is not packaged as part of the container image 103a. Instead, the dynamic code 125 corresponds to external code that is retrieved while the container instance is running and/or during instantiation of the container. Accordingly, two instances 103a′, 103a″ of the same container image 103a can have dynamic code components 125 that differ if each instance 103a′, 103a″ retrieves different external code.

In the present embodiment, the code execution module 121 first utilizes fixed code 123 to retrieve external data 129 and dynamic code 125. As an example, the fixed code 123 can retrieve the external data 129 from a specified location from one or more data sources 113. Similarly, the fixed code 123 can retrieve the dynamic code 125 from a specified location on external code storage 109. In the present embodiment, the external data 129 and dynamic code 125 are provided in a single package 131 such as a ZIP file or other archive. In this fashion, the fixed code 123 can be directed to retrieve a single file and extract the external data 129 and dynamic code 125 from that file. It is appreciated, however, that other configurations are possible. For example, the fixed code 123 can be configured to retrieve external data 129 and dynamic code 125 from a plurality of specified locations, and/or in a plurality of separate packages or archives. In some embodiments, the ZIP file can be prepared in advance (i.e., prior to retrieval by fixed code 123), while in other embodiments the fixed code 123 can send a request to an external service to assemble the external data 129 and dynamic code 125 in a package 131 on demand, prior to retrieving the package 131.

Once the external data 129 and dynamic code 125 are retrieved, the fixed code 123 can cause the dynamic code 125 to be executed. In the present embodiment, the dynamic code 125 comprises a Python script. Accordingly, the code execution module 121 comprises a Python interpreter 121, and the fixed code 123 causes the interpreter 121 to execute the dynamic code 125. It is appreciated, however, that other configurations are possible. For example, a different scripting language and corresponding interpreter can be used, or a combination of different scripting languages and interpreters can be used. Alternatively, some or all of the dynamic code 125 can be compiled code and can be executed by the host machine directly instead of via an interpreter. As can be appreciated, upon execution by code execution module 121, the dynamic code 125 can carry out several functions, including processing at least some of external data 129 and generating an output. During execution, the dynamic code 125 can make calls to functions provided in the fixed code 123, for example by making API calls to libraries that are included as part of the fixed code 123. Such libraries can, for example, be provided in a compiled language such as C++.

Following execution of dynamic code 125, control flow can return to fixed code 123. Fixed code 123 can subsequently execute other blocks of dynamic code 125 if desired. In some embodiments, following execution of dynamic code 125, fixed code 123 can carry out remaining functions of the containerized application. In the present embodiment, the remaining functions comprise generating and managing an output 133. As can be appreciated, the output 133 can be generated at least in part from output of the dynamic code 125. The output 133 can comprise output files, such as logs, processed data, summaries, or reports, which can be stored at a specified external location on output storage 115. The external location can, for example, be provided via a runtime parameter or argument when executing fixed code 123. In this fashion, the output files can persist even once the container instance is stopped. Additionally, or alternatively, at least some of the output 133 can be provided to a user interface, such as a graphical user interface for display.

Although a particular configuration and flow of code execution module 121 has been described, it is appreciated that other configurations are possible. For example, in some embodiments, at least some external data 129 and/or external code can be retrieved by dynamic code 125. Similarly, at least some output 133 can be managed (ex: compiled, stored, displayed, etc.) by dynamic code 125. As another example, in some embodiments, at least some of fixed code 123 can comprise Python or other scripts and can therefore also be executed within interpreter 127. Of course, many other configurations are possible. Preferably, program execution and control start via fixed code 123 and terminate via fixed code 123.

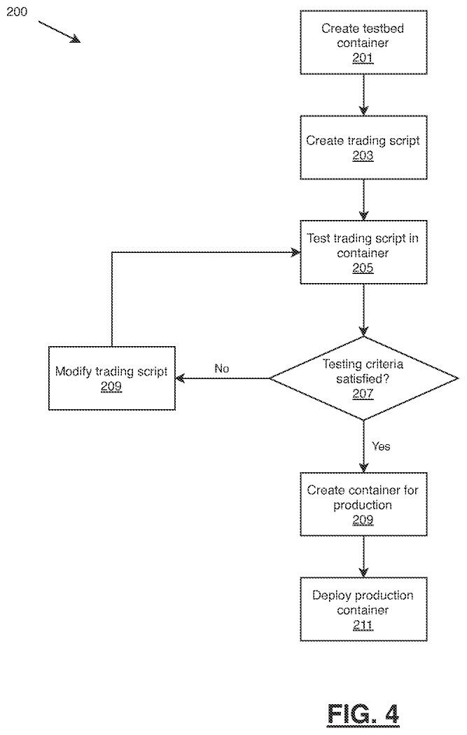

One skilled in the art will appreciate that the above-described systems and methods can be utilized as part of an improved software development process. By way of example, and with reference to FIG. 4, an exemplary software development process 200 is shown according to an embodiment.

A first subprocess 201 can comprise creating a container. In the present embodiment, the container is configured as a testbed for executing and testing trading algorithms coded in a scripting language. Accordingly, the container can include a runtime environment suitable for executing such trading algorithms, including a plurality of libraries and configurations that can be utilized by the trading algorithms, and an interpreter for the scripting language, such as a Python interpreter. The container can further include fixed code for carrying out steps prior to and/or following the execution of the trading algorithms. As an example, the fixed code can include a code import module for retrieving the trading algorithm scripts (i.e., dynamic code) and/or relevant testing data from one or more external sources. The fixed code can further include an output module for compiling results of the trading algorithms and/or generating a summary or report therefrom. The output module can also be configured to externally store and/or display the trading algorithm results and/or reports generated therefrom. The created container can subsequently be saved as a container image and pushed to an image registry so that it can accessed by other users.

A second subprocess 203 can comprise creating a trading script. During this subprocess, a user can write a customized trading algorithm in a scripting language such as Python. As can be appreciated, multiple users can independently and/or concurrently work on separate trading algorithms and create their own scripts. The scripts can subsequently be stored on code storage, such as on a code repository.

A subsequent subprocess 205 can comprise testing the trading script. In the present embodiment, testing the trading script comprises backtesting the trading algorithm using historical data to determine whether the algorithm meets predetermined criteria (such as a minimum profitability). The container can be configured to carry out this testing by retrieving the trading script, retrieving the required historical data, and executing the trading script to operate on the historical data. The container can further be configured to process and/or analyze an output or result of the trading algorithm, for example to calculate profitability of trades.

As can be appreciated, testing of a trading script can be initiated by a user. In particular, the user can cause an instance of the testbed container to be created from the container image and can initialize or configure the testbed container to conduct the test in a desired manner. For example, the user can provide various parameters to the testbed container, including a location of the trading script to test, start and end dates of historical trading data to be used, specific stocks whose historical trading data is to be used, specific markets whose historical trading data is to be used (ex. TSX, NASDAQ, etc.), among others. Based on these parameters, the testbed container can retrieve the trading script from the specified location, retrieve the relevant historical data (ex: from an appropriate data source and within the specified date range), execute the trading script using the relevant historical data, and generate a result or output.

Once the trading script has been executed, the results can be analyzed to determine whether the script meets predefined testing criteria 207. For example, it can be determined whether the backtested trading algorithm has a profitability that is above a minimum threshold. If the criteria are not satisfied, the user can modify the trading script 209, for example by tweaking the algorithm to improve its effectiveness and fixing any relevant bugs. The modified trading script can subsequently be tested in the same manner as described in subprocess 205, for example by creating a new instance of the testbed container to test the modified script. Alternatively, in some embodiments, the same instance of the container can be used to test the modified script.

This process of modifying and re-testing the trading algorithm can continue until the testing criteria are satisfied 207. Once the algorithm is satisfactory, the algorithm can be prepared for deployment in a production environment. In particular, this can include incorporating the trading algorithm into a new container that is suitable for production 209. In some embodiments, this process can involve optimizing the container, for example by re-writing or translating the trading script in a compiled language such as C++. As another example, this can involve making the production container more lightweight by removing any unused libraries or code, such as testing code and/or computational libraries that were included in the testbed container but not actually used by the final trading algorithm. An image of the optimized container can then be created and saved in a registry, and instances of the optimized container can be deployed in a production environment 211.

It should be appreciated that the above-described process can allow multiple users to develop and test trading scripts concurrently and/or independently. In particular, a plurality of users can work on their own trading scripts, and each user can create a dedicated instance of the testbed container to test and validate their scripts. In some embodiments, different trading algorithms that were created by different users can ultimately be packaged in a single production container for deployment.

Although process 200 was described in connection with developing trading algorithms, it is appreciated that the process can apply to other cases as well. For example, a similar process can apply to developing AI models. In such cases, an AI model can be coded in a scripting language, and the testbed container can be configured to retrieve the AI model script, retrieve relevant training and test data, execute the script to train the AI model on the training data, and test the trained AI model on the test data to assess the AI model's predictive power. The AI model script can subsequently be modified and retested as required until it performs as desired, and the AI model can be rewritten in a compiled language and containerized for production. Of course, many other use cases for process 200 are also possible.

As can be appreciated, the above-described systems and methods can provide several advantages. In particular, the ability to re-use a container to test multiple iterations of code facilitates a rapid and efficient software development lifecycle. It also avoids having to maintain and store many different container images that would otherwise be required each time a container is modified. Although some features and advantages have been described herein, other features and advantages may become apparent to a person skilled in the art when reading the present disclosure. The invention is not limited to the embodiments described, and one skilled in the art will understand that numerous modifications can be made without departing from the scope of the invention.

1. A method for executing dynamic code in a container image, comprising:
running a first instance of the container image on a first host server;
retrieving first computer code from a first defined location external to the container image;
causing a code execution module in the first instance of the container image to execute the retrieved computer code;
running a second instance of the container image on the first host server or on a second host server;
retrieving second computer code from a second defined location external to the container image; and
causing a code execution module in the second instance of the container image to execute the retrieved second computer code.

2. The method according to claim 1, wherein the first or second defined location comprises an address of a remote server that is separate from the first host server and the second host server, further wherein the first or second computer code is retrieved from the remote server.

3. The method according to claim 2, wherein the remote server comprises cloud storage.

4. The method according to claim 1, comprising copying the first or second computer code on storage accessible by the first host server or the second host server, wherein retrieving the first or second computer code comprises mounting the storage as a volume accessible by the first or second instance container image.

5. The method according to claim 1, wherein retrieving the first or second computer code comprises downloading the first or second computer code into the instance of the container image.

6. The method according to claim 1, further comprising retrieving data from a data source external to the container image, wherein the first or second retrieved computer code causes the code execution module to process at least some of the retrieved data.

7. The method according to claim 6, wherein the first or second retrieved computer code initiates the retrieval of at least some of the data from the data source.

8. The method according to claim 1, comprising causing the code execution module of the first or second instance of the container image to execute fixed computer code stored in the container image prior to executing the first or second retrieved computer code.

9. The method according to claim 8, wherein the fixed computer code comprises compiled computer instructions and/or instructions written in a scripting language.

10. The method according to claim 1, wherein the first or second retrieved computer code comprises instructions written in a scripting language.

11. The method according to claim 1, wherein the first or second retrieved computer code comprises Python instructions, further wherein the code execution module in the first or second instance of the container image comprises a Python interpreter.

12. The method according to claim 1, wherein the first defined location is different than the second defined location.

13. The method according to claim 1, wherein the second instance of the container image is run concurrent with the first instance of the container image.

14. The method according to claim 1, wherein the second retrieved computer code is different than the first retrieved computer code.

15. The method according to claim 14, wherein the second retrieved computer code comprises a modified copy of the first retrieved computer code.

16. The method according to claim 1, wherein the first retrieved computer code and the second retrieved computer code are executed in an identical internal runtime environment defined by the container image.

17. The method according to claim 1, wherein the first instance of the container image and the second instance of the container image are run in an identical external runtime environment defined by the first host server and the second host server.

18. The method according to claim 1, further comprising, after the first retrieved computer code is executed:
modifying the first computer code at the location external to the container image;
retrieving the modified computer code from the location external to the container image; and
causing the code execution module in the first or second instance of the container image to execute the retrieved modified computer code.

19. The method according to claim 18, wherein retrieving and executing the modified computer code are carried out by the first instance of the container image, further wherein modifying the first computer code is carried out while the first instance of the container image is running and without running a new instance of the container image.

20. The method according to claim 18, wherein retrieving and executing the modified computer code are carried out by the second instance of the container image, the method further comprising stopping the first instance of the container image prior to executing the modified computer code.

21. The method according to claim 1, further comprising storing an output of the executed first or second retrieved computer code on storage external to the first or second instance of the container image.

22. The method according to claim 21, wherein the storage external to the first or second instance of the container image is persistent storage that retains stored data when the first or second instance of the container image is stopped.

23. The method according to claim 1, further comprising:
validating an output of the executed first or second retrieved computer code; and
if the output is positively validated, generating a new container image comprising the first or second retrieved computer code integrated therein.

24. The method according to claim 23, further comprising converting the first or second retrieved computer code into compiled instructions for integration into the new container image.

25. The method according to claim 23, further comprising running one or more instances of the new container image on a production server.

26. The method according to claim 1, wherein the first or second retrieved computer code comprises a trading algorithm.

27. The method according to claim 1, wherein the first or second retrieved computer code comprises an artificial intelligence algorithm.

28. The method according to claim 1, wherein running the first or second instance of the container image comprises retrieving, on the first host server or the second host server, a copy of the container image from an image repository, and running the retrieved copy of the container image on the first host server or the second host server.

29. A non-transitory computer-readable medium having instructions stored thereon which, when executed by one or more processors, cause the one or more processors to:
run a first instance of a container image on a first host server;
retrieve first computer code from a first defined location external to the container image;
cause a code execution module in the first instance of the container image to execute the retrieved computer code;
run a second instance of the container image on the first host server or on a second host server;
retrieve second computer code from a second defined location external to the container image; and
cause a code execution module in the second instance of the container image to execute the retrieved second computer code.

30. A system for executing dynamic code, comprising:
memory storing a container image, said container image comprising:
a code import module configured to retrieve computer code from a defined location external to the container image; and
a code execution module configured to execute the retrieved computer code;
a first instance of the container image running on a first host server, wherein:
the code import module of the first instance of the container image is configured to retrieve first computer code from a first defined location external to the first instance of the container image; and
the code execution module of the first instance of the container image is configured to execute the first retrieved computer code; and
a second instance of the container image running on the first host server or on a second host server, wherein:
the code import module of the second instance of the container image is configured to retrieve second computer code from a second defined location external to the second instance of the container image; and
the code execution module of the second instance of the container image is configured to execute the second retrieved computer code.

31. The system according to claim 30, wherein the first or second defined location comprises an address of a remote server that is separate from the first or second host server, further wherein the code import module of the container image is configured to retrieve the computer code from the remote server.

32. The system according to claim 30, wherein the first or second instance of the container image is run with a mounted volume, said mounted volume corresponding to storage accessible by the first or second host server comprising the first or second computer code.
